(19) United States
(12) Patent Application Publication
(10) Pub. No.: US 2020/0055485 A1
(43) Pub. Date: Feb. 20, 2020

(54) AIRBRAKE LOCKING ASSEMBLY

(71) Applicant: Raymond Woods, East Palestine, OH (US)

(72) Inventor: Raymond Woods, East Palestine, OH (US)

(21) Appl. No.: 16/105,839

(22) Filed: Aug. 20, 2018

(51) Int. Cl. B60R 25/08; B60T 17/18; B60T 7/10; G05G 5/28; G05G 5/00; E05B 73/00

(52) U.S. Cl. CPC B60R 25/086; B60T 17/18; E05B 73/00; G05G 5/28; G05G 5/005; B60T 7/101

(57) ABSTRACT

An airbrake locking assembly for keeping parking brake engaged on a vehicle with airbrakes includes a vehicle that has airbrakes which include a parking brake plunger. The parking brake plunger is positionable in an actuated position and an un-actuated position. A collar is provided that has a first half being pivotally coupled to a second half. The collar is positionable around the parking brake plunger when the parking brake plunger is positioned in the actuated position. Moreover, the collar inhibits the parking brake plunger from being urged into the un-actuated position when the collar is positioned around the parking brake plunger. In this way the vehicle is retained in a parked position thereby enhancing safety for individuals entering and exiting the vehicle. A lock is coupled to first half of the collar and releasably engages the second half.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

(2) Description of Related Art including information disclosed under 37 CFR 1.97 and 1.98.

The disclosure and prior art relates to locking devices and more particularly pertains to a new locking device for keeping a parking brake engaged on a vehicle with airbrakes.

### BRIEF SUMMARY OF THE INVENTION

An embodiment of the disclosure meets the needs presented above by generally comprising a vehicle that has airbrakes which include a parking brake plunger. The parking brake plunger is positionable in an actuated position and an un-actuated position. A collar is provided that has a first half being pivotally coupled to a second half. The collar is positionable around the parking brake plunger when the parking brake plunger is positioned in the actuated position. Moreover, the collar inhibits the parking brake plunger from being urged into the un-actuated position when the collar is positioned around the parking brake plunger. In this way the vehicle is retained in a parked position thereby enhancing safety for individuals entering and exiting the vehicle. A lock is coupled to first half of the collar and releasably engages the second half.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of collar of an airbrake locking assembly according to an embodiment of the disclosure.

FIG. 2 is a front phantom view of a collar of an embodiment of the disclosure.

FIG. 3 is a top phantom view of a collar of an embodiment of the disclosure.

FIG. 4 is a front exploded view of an embodiment of the disclosure.

FIG. 5 is a front perspective in-use view of an embodiment of the disclosure.

FIG. 6 is a phantom in-use view of an embodiment of the disclosure.

### DETAILED DESCRIPTION OF THE INVENTION

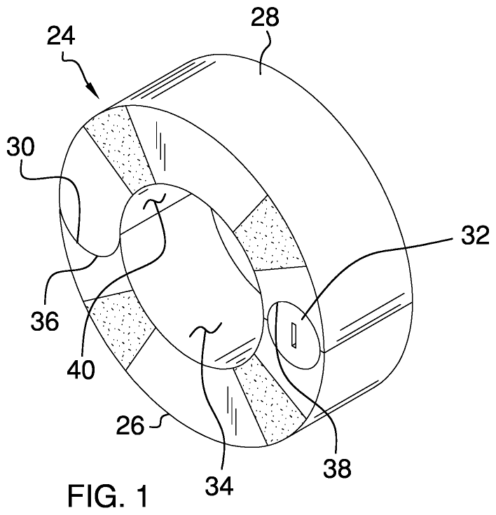

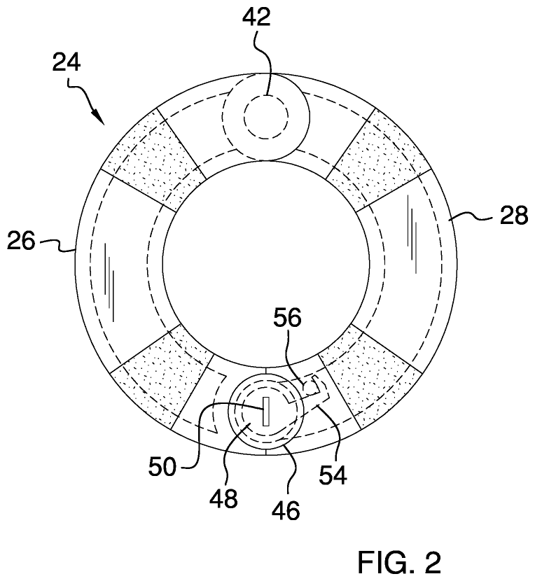

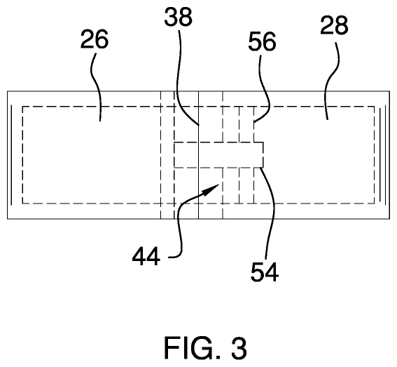

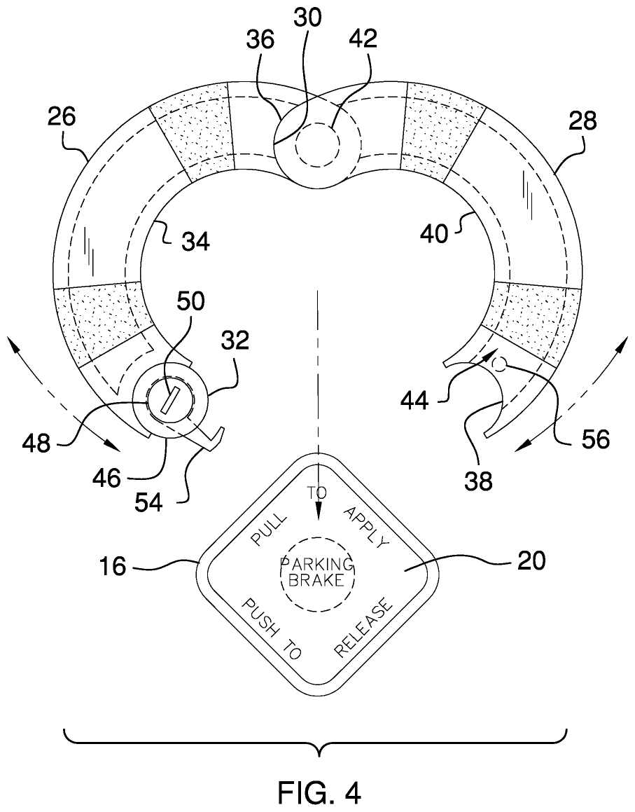

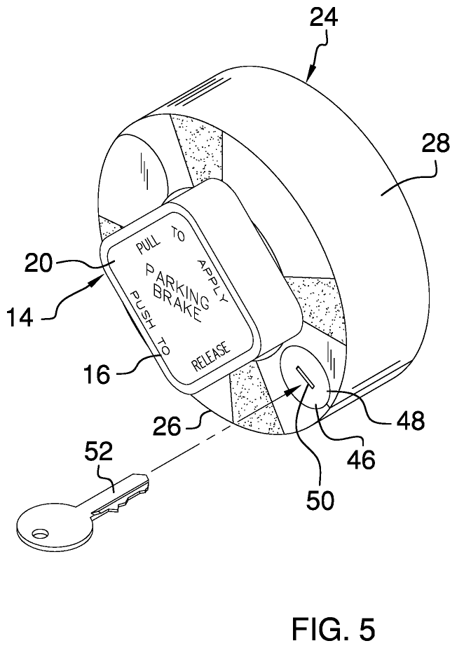

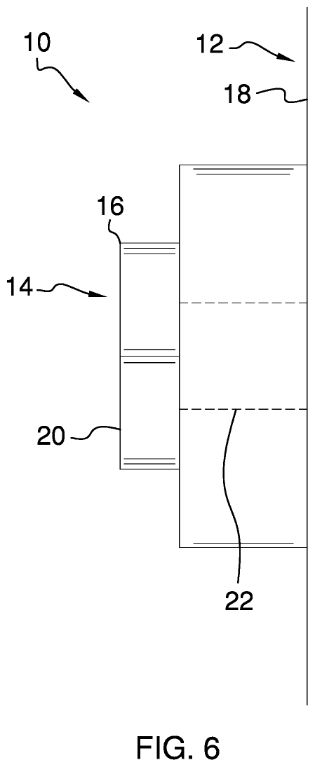

With reference now to the drawings, and in particular to FIGS. 1 through 6 thereof, a new locking device embodying the principles and concepts of an embodiment of the disclosure and generally designated by the reference numeral 10 will be described.

As best illustrated in FIGS. 1 through 6, the airbrake locking assembly 10 generally comprises a vehicle 12 that has airbrakes 14 and the airbrakes 14 include a parking brake plunger 16. The parking brake plunger 16 is positionable in an actuated position having the parking brake plunger 16 being urged away from a dashboard 18 of the vehicle 12. Additionally, the parking brake plunger 16 is positionable in an un-actuated position having the parking brake plunger 16 being urged toward the dashboard 18. The vehicle 12 may be a public transportation bus or other type of large vehicle that has air brakes and that is commonly parked in crowded parking lots or other areas that involves people walking around the vehicle 12 when the vehicle 12 is parked. The airbrakes 14 may be vehicle airbrakes of any conventional design and the parking brake plunger 16 has a head 20 and a stem 22.

A collar 24 is provided that has a first half 26 being pivotally coupled to a second half 28. A collar 24 is positionable around the parking brake plunger 16 when the parking brake plunger 16 is positioned in the actuated position. Thus, the collar 24 inhibits the parking brake plunger 16 from being urged into the un-actuated position when the collar 24 is positioned around the parking brake plunger 16. In this way the airbrakes 14 are engaged to retain the vehicle 12 in a parked position thereby enhancing safety for individuals entering and exiting the vehicle 12. Moreover, the collar 24 inhibits the airbrakes 14 from being inadvertently disengaged and potentially exposing the individuals to injury due to the vehicle 12 rolling. The collar 24 may be brightly colored with a color that contrasts to the color of the parking brake plunger 16 for enhancing visibility of the collar 24.

The first half 26 has a first end 30, a second end 32 and a first surface 34 extending therebetween. The first surface 34 is concavely arcuate between the first 30 and second 32 ends such that the first half 26 forms a U shape. Additionally, the first end 30 is concavely arcuate and the second end 32 is convexly arcuate. The second half 28 has a primary end 36, a secondary end 38 and a primary surface 40 extending therebetween. The primary surface 40 is concavely arcuate between each of the primary 36 and secondary 38 ends such that the second half 28 has a U shape. Additionally, the primary end 36 is convexly arcuate and the secondary end 38 is concavely arcuate.

The first end 30 of the first half 26 has the primary end 36 of the second half 28 being pivotally positioned therein such that the curvature of the primary end 36 conforms to the curvature of the first end 30. A pin 42 or the like extends through each of the first end 30 and the primary end 36 to pivotally couple the first half 26 to the second half 28. The second end 32 has the secondary end 38 positioned therein when the collar 24 is positioned in a closed position such that the collar 24 forms a closed ring. Moreover, the curvature of the secondary end 38 conforms to the curvature of the second end 32 when the collar 24 is closed.

Each of the first 26 and second 28 halves extends around the stem 22 of the parking brake plunger 16 when the collar 24 is positioned around the parking brake plunger 16. In this way the head 20 abuts the collar 24 when the head 20 is engaged thereby inhibiting the head 20 from being urged toward the dashboard 18. Thus, the parking brake plunger 16 is inhibited from being urged into the un-acuated position. The second end 32 is spaced from the secondary end 38 when the collar 24 is positioned in an open position thereby facilitating the collar 24 to be removed from the stem 22 or positioned around the stem 22. Additionally, the secondary end 38 of the second half 28 has a well 44 extending therein.

A lock 46 is provided and the lock 46 is coupled to first half 26 of the collar 24. The lock 46 releasably engages the second half 28 when the collar 24 is positioned around the parking brake plunger 16 thereby inhibiting the collar 24 from being removed from the parking brake plunger 16. The lock 46 is selectively disengaged from the second half 28 thereby facilitating the collar 24 to be removed from the parking brake plunger 16. The lock 46 comprises a key tumbler 48 that is positioned within the first half 26. The key tumbler 48 is aligned with the second end 32 of the first half 26 and the key tumbler 48 has a key slot 50 therein for insertably receiving a key 52. The key 52 actuates the key tumbler 48 between a locked position and an unlocked position.

A finger 54 is coupled to the key tumbler 48 having the finger 54 extending outwardly from the second end 32 of the first half 26. The finger 54 extends into the well 44 in the secondary end 38 of the second half 28 when the collar 24 is the closed position. Moreover, the finger 54 engages an engagement 56 in the well 44 in the secondary end 38 of the second half 28 when the key tumbler 48 is acuated into the locked position. In this way the collar 24 is retained in the closed position around the parking brake plunger 16. The finger 54 disengages the engagement 56 in the well 44 when the key tumbler 48 is actuated into the unlocked position thereby facilitating the collar 24 to be urged into the open position.

In use, the parking brake plunger 16 is pulled outwardly from the dashboard 18 to engage the airbrakes 14 in the vehicle 12 for parking. The collar 24 is positioned around the stem 22 of the parking brake plunger 16 and the collar 24 is closed around the stem 22. Thus, the finger 54 engages the engagement 56 in the well 44 thereby locking the collar 24 around the stem 22. The head 20 abuts the collar 24 when the parking brake plunger 16 is pushed toward the dashboard 18. In this way the collar 24 inhibits the parking brake plunger 16 from being fully pushed toward the dashboard 18 and consequently disengaging the airbrakes 14. Thus, the collar 24 reduces the likelihood the individuals, such as passengers on and around a bus, are struck by the vehicle 12 if the vehicle 12 begins to roll due to the airbrakes 14 being disengaged. Additionally, the collar 24 cannot be removed from the parking brake plunger 16 without the key 52. In this way the airbrakes 14 cannot be disengaged until the key 52 is inserted into the key tumbler 48, the collar 24 is unlocked and the collar 24 is removed from the stem 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An airbrake locking assembly being configured to inhibit airbrakes on a vehicle from being inadvertently released, said assembly comprising:
a vehicle having airbrakes, said airbrakes including a parking brake plunger, said parking brake plunger being positionable in an actuated position having said parking brake plunger being urged away from a dashboard of said vehicle, said parking brake plunger being positionable in an un-actuated position having said parking brake plunger being urged toward said dashboard;
a collar having a first half being pivotally coupled to a second half, said collar being positionable around said parking brake plunger when said parking brake plunger is positioned in said actuated position, said collar inhibiting said parking brake plunger from being urged into said un-actuated position when said collar is positioned around said parking brake plunger thereby retaining said vehicle in a parked position thereby enhancing safety for individuals entering and exiting said vehicle; and
a lock being coupled to first half of said collar, said lock releasably engaging said second half when said collar is positioned around said parking brake plunger thereby inhibiting said collar from being removed from said parking brake plunger, said lock being selectively disengaged from said second half thereby facilitating said collar to be removed from said parking brake plunger.

2. The assembly according to claim 1, wherein:
said first half has a first end, a second end and a first surface extending therebetween, said first surface being concavely arcuate between said first and second ends such that said first half forms a U shape, said first end being concavely arcuate, said second end being convexly arcuate; and
said second half has a primary end, a secondary end and a primary surface extending therebetween, said primary surface being concavely arcuate between each of said primary and secondary ends such that said second half has a U shape, said primary end being convexly arcuate, said secondary end being concavely arcuate, said first end of said first half having said primary end of said second half being pivotally positioned therein, said second end having said secondary end being positioned therein when said collar is positioned in a closed position such that said collar forms a closed ring, said secondary end of said second half having a well extending therein.

3. The assembly according to claim 2, wherein:
said parking brake plunger has a head and a stem; and
each of said first and second halves extends around said stem of said parking brake plunger when said collar is positioned around said parking brake plunger, said head abutting said collar when said head is engaged thereby inhibiting said head from being urged toward said dashboard, said second end being spaced from said secondary end when said collar is positioned in an open position thereby facilitating said collar to be removed from said stem or positioned around said stem.

4. The assembly according to claim 2, wherein said lock comprises a key tumbler being positioned within said first half, said key tumbler being aligned with said second end of said first half, said key tumbler having a key slot therein for insertably receiving a key, said key actuating said key tumbler between a locked position and an unlocked position.

5. The assembly according to claim 4, wherein:
said lock includes a finger being coupled to said key tumbler having said finger extending outwardly from said second end of said first half, said finger extending into said well in said secondary end of said second half when said collar is said closed position;
said finger engages an engagement in said well in said secondary end of said second half when said key tumbler is acuated into said locked position thereby retaining said collar in said closed position; and
said finger disengages said engagement in said well when said key tumbler is actuated into said unlocked position thereby facilitating said collar to be urged into said open position.

6. An airbrake locking assembly being configured to inhibit airbrakes on a vehicle from being inadvertently released, said assembly comprising:
a vehicle having airbrakes, said airbrakes including a parking brake plunger, said parking brake plunger being positionable in an actuated position having said parking brake plunger being urged away from a dashboard of said vehicle, said parking brake plunger being positionable in an un-actuated position having said parking brake plunger being urged toward said dashboard, said parking brake plunger having a head and a stem;
a collar having a first half being pivotally coupled to a second half, said collar being positionable around said parking brake plunger when said parking brake plunger is positioned in said actuated position, said collar inhibiting said parking brake plunger from being urged into said un-actuated position when said collar is positioned around said parking brake plunger thereby retaining said vehicle in a parked position thereby enhancing safety for individuals entering and exiting said vehicle, said first half having a first end, a second end and a first surface extending therebetween, said first surface being concavely arcuate between said first and second ends such that said first half forms a U shape, said first end concavely arcuate, said second end being convexly arcuate, said second half having a primary end, a secondary end and a primary surface extending therebetween, said primary surface being concavely arcuate between each of said primary and secondary ends such that said second half has a U shape, said primary end being convexly arcuate, said secondary end being concavely arcuate, said first end of said first half having said primary end of said second half being pivotally positioned therein, said second end having said secondary end being positioned therein when said collar is positioned in a closed position such that said collar forms a closed ring, each of said first and second halves extending around said stem of said parking brake plunger when said collar is positioned around said parking brake plunger, said head abutting said collar when said head is engaged thereby inhibiting said head from being urged toward said dashboard, said second end being spaced from said secondary end when said collar is positioned in an open position thereby facilitating said collar to be removed from said stem or positioned around said stem, said secondary end of said second half having a well extending therein; and
a lock being coupled to first half of said collar, said lock releasably engaging said second half when said collar is positioned around said parking brake plunger thereby inhibiting said collar from being removed from said parking brake plunger, said lock being selectively disengaged from said second half thereby facilitating said collar to be removed from said parking brake plunger, said lock comprising:
a key tumbler being positioned within said first half, said key tumbler being aligned with said second end of said first half, said key tumbler having a key slot therein for insertably receiving a key, said key actuating said key tumbler between a locked position and an unlocked position; and
a finger being coupled to said key tumbler having said finger extending outwardly from said second end of said first half, said finger extending into said well in said secondary end of said second half when said collar is said closed position, said finger engaging an engagement in said well in said secondary end of said second half when said key tumbler is acuated into said locked position thereby retaining said collar in said closed position, said finger disengaging said engagement in said well when said key tumbler is actuated into said unlocked position thereby facilitating said collar to be urged into said open position.
